(19) United States
(12) Patent Application Publication
(10) Pub. No.: US 2026/0140092 A1
(43) Pub. Date: May 21, 2026

(54) METHOD AND APPARATUS FOR MEASURING ULTRASONIC VISCOELASTICITY, DEVICE AND MEDIUM

(71) Applicant: Shenzhen University, Shenzhen (CN)

(72) Inventors: Xin Chen, Shenzhen (CN); Zhongjun Ma, Shenzhen (CN); Mian Chen, Shenzhen (CN); Haoming Lin, Shenzhen (CN); Siping Chen, Shenzhen (CN)

(21) Appl. No.: 19/257,174

(22) Filed: Jul. 1, 2025

(30) Foreign Application Priority Data
Nov. 20, 2024 (CN) 202411657803.4

(51) Int. Cl. G01N 29/44; G01N 29/04

(52) U.S. Cl. CPC G01N 29/4481; G01N 29/043; G01N 29/4418; G01N 2291/02818; G01N 2291/02827; G01N 2291/0422

(57) ABSTRACT

A method and an apparatus for measuring ultrasonic viscoelasticity, a device and a medium are provided. The method includes: establishing an inhomogeneous viscoelastic wave equation; coding the inhomogeneous viscoelastic wave equation as a loss function, and constructing a physics-informed neural network, where the spatial-temporal neural network is configured to predict a stream function, the inhomogeneous viscoelastic wave equation is used to obtain vertical vibration velocity of particles based on the stream function outputted, the spatial neural network is configured to predict shear modulus and viscosity, and the loss function is used to calculate an aggregate loss; inputting the multi-frame vertical vibration velocity of particles of the object to be measured as supervisory data into the physics-informed neural network, to obtain a spatial distribution of the shear modulus and a spatial distribution of the viscosity of the object to be measured.

### CROSS-REFERENCE TO RELATED APPLICATION

This patent application claims the benefit and priority of Chinese Patent Application No. 202411657803.4 filed with the China National Intellectual Property Administration on Nov. 20, 2024, the disclosure of which is incorporated by reference herein in its entirety as part of the present application.

### TECHNICAL FIELD

The present disclosure relates to the field of shear wave elastography, and in particular to a method and apparatus for measuring ultrasonic viscoelasticity, a device and a medium.

### BACKGROUND

At present, shear wave elastography (SWE) has been widely used in clinic, which is mainly used for staging liver fibrosis, detecting arterial stiffness and differentiating benign from malignant tumors. However, the traditional SWE method usually adopts a shear-wave Time of Flight (ToF) method, which relies on the shear wave velocity to estimate the viscoelastic properties of tissues. This method performs well in dealing with large tissue structures, but it often produces large errors when encountering inclusions with sizes less than about 1 cm. This is because the estimation of shear wave velocity is essentially a macro measurement, with resolution limited by a wavelength and a sampling frequency. When there are fine structures or complex geometric shapes in tissues, a mechanical inverse estimation method that relies solely on shear wave velocity often fail to accurately capture these microscopic features, which affects the precise estimation of viscoelastic distribution within complex human soft tissues.

In recent years, deep learning (DL), as a powerful data-driven tool, has made remarkable progress in many fields. The deep learning relies on an improved artificial neural network, and is composed of multiple processing layers, which can automatically extract and learn representative features of input data. In the field of medical image analysis, DL has been proved to be able to identify and analyze complex image patterns. SWE method based on deep learning can extract rich information from spatial and temporal characteristics of shear waves through the training process, which has a potential to overcome the limitations of traditional methods and can provide more accurate estimation of tissue viscoelastic distribution.

Nevertheless, the current SWE method based on deep learning still faces challenges, especially in the case of viscoelastic materials, the dynamic response of these viscoelastic materials is not only affected by elastic modulus, but also related to the viscosity. Therefore, it is particularly important to develop techniques capable of accurately estimating spatial distributions of shear modulus and viscosity.

### SUMMARY

An objective of the present disclosure is to provide a method and apparatus for measuring ultrasonic viscoelasticity, a device and a medium, which can accurately estimate spatial distributions of shear modulus and viscosity, and improve prediction accuracy of elasticity.

To achieve the objective above, the present disclosure provides the following solutions.

In a first aspect, the present disclosure provides a method for measuring ultrasonic viscoelasticity, including: establishing an inhomogeneous viscoelastic wave equation, where the inhomogeneous viscoelastic wave equation characterizes a relationship between particle vertical vibration velocity and a stream function; coding the inhomogeneous viscoelastic wave equation as a loss function, and constructing a physics-informed neural network, where the physics-informed neural network includes a spatial-temporal neural network, a spatial neural network and the loss function, the spatial-temporal neural network is configured to predict the stream function, the inhomogeneous viscoelastic wave equation is used to obtain the particle vertical vibration velocity based on the stream function outputted, the spatial neural network is configured to predict shear modulus and viscosity, and the loss function is used to calculate an aggregate loss based on the particle vertical vibration velocity, the shear modulus and the viscosity; determining multi-frame particle vertical vibration velocity of an object to be measured based on consecutive frames of ultrasonic radio frequency signals of the object to be measured; and inputting the multi-frame particle vertical vibration velocity of the object to be measured as supervisory data into the physics-informed neural network, to obtain a spatial distribution of the shear modulus and a spatial distribution of the viscosity of the object to be measured.

In a second aspect, the present disclosure provides an apparatus for measuring ultrasonic viscoelasticity, including an equation establishing module, a neural network constructing module, a vibration velocity determining module, and an application module. The equation establishing module is configured to establish an inhomogeneous viscoelastic wave equation, where the inhomogeneous viscoelastic wave equation characterizes a relationship between particle vertical vibration velocity and a stream function. The neural network construction module is configured to code the inhomogeneous viscoelastic wave equation as a loss function and construct a physics-informed neural network, where the physics-informed neural network includes a spatial-temporal neural network, a spatial neural network and the loss function, the spatial-temporal neural network is configured to predict the stream function, the inhomogeneous viscoelastic wave equation is used to obtain particle vertical vibration velocity based on the stream function outputted, the spatial neural network is configured to predict shear modulus and viscosity, and the loss function is used to calculate an aggregate loss based on the particle vertical vibration velocity, the shear modulus and the viscosity. The vibration velocity determining module is configured to determine multi-frame particle vertical vibration velocity of an object to be measured based on consecutive frames of ultrasonic radio frequency signals of the object to be measured. The application module is configured to input the multi-frame particle vertical vibration velocity of the object to be measured as supervisory data into the physics-informed neural network, to obtain a spatial distribution of the shear modulus and a spatial distribution of the viscosity of the object to be measured.

In a third aspect, the present disclosure provides a computer device, including a memory, a processor, and a computer program stored in the memory and executable on the processor. The processor is configured to execute the computer program to implement the method for measuring ultrasonic viscoelasticity in any one of the above.

In a fourth aspect, the present disclosure provides a computer readable storage medium. A computer program is stored on the computer readable storage medium, and the computer program, when executed by a processor, implement the method for measuring ultrasonic viscoelasticity in any one of the above.

According to specific embodiments of the present disclosure, the present disclosure has the following technical effects.

The present disclosure provides a method and apparatus for measuring ultrasonic viscoelasticity, a device and a medium, in which a physics-informed neural network is applied to inverse estimation of tissue viscoelasticity of shear wave elastography. Compared with a traditional shear-wave time-of-flight method based on shear wave velocity, the physics-informed neural network can extract more spatial-temporal characteristics of shear waves, which has inverse estimation accuracy far higher than that of the traditional shear-wave time-of-flight method based on shear wave velocity in a complex environment, and can avoid an estimation error caused by wave reflection and scattering to the greatest extent. Moreover, the physics-informed neural network can achieve the spatial distribution of shear modulus and the spatial distribution of viscosity at the same time, which improves the prediction accuracy of elasticity.

### BRIEF DESCRIPTION OF THE DRAWINGS

To describe the technical solutions in the embodiments of the present disclosure or in the prior art more clearly, the following briefly introduces the accompanying drawings required for describing the embodiments. Apparently, the accompanying drawings in the following description show merely some embodiments of the present disclosure, and those of ordinary skill in the art may still derive other drawings from these accompanying drawings without creative efforts.

FIG. 1 is a flow diagram of a method for measuring ultrasonic viscoelasticity according to an embodiment of the present disclosure;

FIG. 2 is a structural diagram of a physics-informed neural network according to another embodiment of the present disclosure; and

FIG. 3 is a structural diagram of a computer device according to an embodiment of the present disclosure.

### DETAILED DESCRIPTION OF THE EMBODIMENTS

The following clearly and completely describes the technical solutions in the embodiments of the present disclosure with reference to the accompanying drawings in the embodiments of the present disclosure. Apparently, the described embodiments are merely a part rather than all of the embodiments of the present disclosure. All other embodiments obtained by those of ordinary skill in the art based on the embodiments of the present disclosure without creative efforts shall fall within the protection scope of the present disclosure.

To make the objectives, features and advantages of the present disclosure more clearly, the present disclosure is further described in detail with reference to the accompanying drawings and specific embodiments.

Because the occurrence and development of diseases are usually accompanied by the changes of mechanical properties thereof, shear wave elastography can measure mechanical parameters (elasticity, viscosity, etc.) of soft tissues in vivo, which has broad clinical application prospects.

The traditional SWE method generally adopts a ToF method, which relies on the estimation of shear wave velocity. The shear wave velocity is usually regarded as an important substitute index of tissue elasticity, and can be estimated by analyzing a series of images of spatial-temporal data of the shear waves. This process is usually implemented by two main steps. Firstly, propagation time of the shear wave is calculated by performing cross-correlation analysis on two time-varying signals with known distances or performing linear regression on a peak in two-dimensional spatial-temporal images. The ToF method is based on an assumption that shear wave propagates in a fixed direction, so it is necessary to perform directional filtering on the signal before cross-correlation analysis. Secondly, the calculation of viscosity usually relies on slope variation of shear wave velocity under different excitation frequencies, and this slope can be used to characterize viscoelastic properties of tissues.

The ToF method has become the most commonly used viscoelastic estimation method in clinic because of its relatively simple operation and high measurement accuracy. However, this method has a significant error when treating an inhomogeneous material, which is especially apparent in inhomogeneous tissues. This error comes from idealized assumption of the ToF method about a shear wave propagation path and medium uniformity, which is often not true in complex biological tissues. Therefore, the error of ToF method under certain circumstances has become one of the major challenges in the clinical application of shear wave elastography technology, leading to a limitation on its application in accurate viscoelastic measurement.

Convolutional Neural Network (CNN) has been widely used in various image processing and pattern recognition tasks, especially demonstrates remarkable performance in extracting the temporal and spatial characteristics during the wave propagation. Through the characteristics of automatic learning and data-driven, CNN can effectively capture the complex patterns in shear wave propagation. However, the training of CNN usually depends on a large number of high-quality data sets, especially in the field of medical imaging, making it extremely difficult to obtain the shear wave propagation data in the real human body. At the present stage, most studies rely on numerical simulation, phantom experiment and ex vivo tissue experiment data to generate training data sets for training model.

However, there is a certain difference between a training mode based on simulation and phantom data and an actual situation of real human tissues, which limits the generalization and interpretability of a model when applied to real human bodies. In addition, “black box” characteristics of CNN in a deep learning model make it difficult to explain and analyze, which further limits its potential in clinical transformation. Therefore, although CNN has certain advantages in wave propagation analysis, its limitations also significantly hinder its wide application in shear wave elastography.

Therefore, the current SWE technology has the following problems and improvement direction.
(1) The traditional SWE method relies on the estimation of shear wave velocity, and the wave propagation in inhomogeneous soft tissues is prone to reflection and scattering, which makes the estimation of shear wave velocity face a great challenge. Therefore, additional parameters need to be considered in the inverse estimation of tissue mechanical properties, rather than relying solely on the shear wave velocity.
(2) ToF method based on cross-correlation is particularly sensitive to noise, making it difficult to reconstruct a smooth tissue elastic distribution map. Therefore, an inverse estimation algorithm for tissue mechanical properties with strong noise resistance needs to be developed.
(3) Biological tissue is not a simple linear elastic material, but a more complex viscoelastic material. The estimation of tissue elasticity is greatly affected by viscosity distribution. Therefore, there is a need of an algorithm that can achieve spatial distributions of elasticity and viscosity at the same time to improve the prediction accuracy of elasticity.

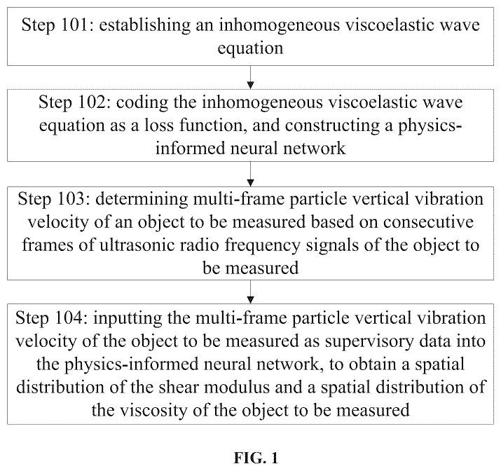

In view of this, in an example embodiment, as shown in FIG. 1, the present disclosure provides a method for measuring ultrasonic viscoelasticity, including the following step 101 to step 104.

In step 101, an inhomogeneous viscoelastic wave equation is established. The inhomogeneous viscoelastic wave equation characterizes a relationship between vertical vibration velocity of particles and a stream function.

In step 102, the inhomogeneous viscoelastic wave equation is coded as a loss function, and a physics-informed neural network is constructed. The physics-informed neural network includes a spatial-temporal neural network and a spatial neural network. The spatial-temporal neural network is configured to predict a stream function, and the inhomogeneous viscoelastic wave equation is used to obtain vertical vibration velocity of particles according to the stream function outputted. The spatial neural network is configured to predict shear modulus and viscosity. The loss function is used to calculate an aggregate loss according to the vertical vibration velocity of particles, the shear modulus and the viscosity.

In step 103, multi-frame vertical vibration velocity of particles of an object to be measured is determined based on consecutive frames of ultrasonic radio frequency signals of the object to be measured.

In step 104, the multi-frame vertical vibration velocity of particles of the object to be measured as supervisory data is input into the physics-informed neural network, to obtain a spatial distribution of the shear modulus and a spatial distribution of the viscosity of the object to be measured.

By implementing step 101 to step 104, a physics-informed neural network (PINN) technology is innovatively applied to inverse estimation of tissue viscoelasticity of SWE, which overcomes clinical application limitations of numerous traditional SWE methods. Compared with the traditional ToF method based on shear wave velocity, PINN can extract more spatial-temporal characteristics of the shear wave, and has inverse estimation accuracy far higher than that of the ToF in a complex environment, thus avoiding an estimation error caused by wave reflection and scattering to the greatest extent. Compared with the traditional convolutional neural network, the physical equation is coded as a loss function, such that instead of learning data features in a disordered manner, the network performs parameter solving by using a physical principle as a guide. This method of embedding physical information makes the neural network no longer rely solely on the stacking of mass training data, which greatly reduces a demand for training data, and even can achieve the accurate solution of singleton data. Meanwhile, this technology can check the solution process of various internal parameters, which greatly improves the interpretability of deep learning. Therefore, this method has application advantages far beyond the prior art.

In another example embodiment of the present disclosure, viscoelastic models are generally divided into Kelvin-Voigt model (in which an elastic element and a viscous element are connected in parallel), Maxwell model (in which an elastic element and a viscous element are connected in series) and other combinations of the both. Considering that a viscoelastic solid problem is studied, Kelvin-Voigt model is chosen as a constitutive equation, and it is assumed that the material satisfies incompressible and isotropic conditions. In this way, the process of establishing the inhomogeneous viscoelastic wave equation in the step 101 above can be replaced by the following steps 201 to 203.

In step 201, based on Newton's second law and a shear stress-shear strain relationship, an expression form of a wave equation about particle displacement for an inhomogeneous medium is determined as follows:

$$ρ \frac{{\partial }^{2} {u}_{i}}{\partial {t}^{2}} = μ \frac{{\partial }^{2} {u}_{i}}{\partial {x}_{j} \partial {x}_{j}} + η \frac{{\partial }^{3} {u}_{i}}{\partial {x}_{j} \partial {x}_{j} \partial t} + \frac{\partial μ}{\partial {x}_{j}} ( \frac{\partial {μ}_{i}}{\partial {x}_{j}} + \frac{\partial {u}_{j}}{\partial {x}_{i}} ) + \frac{\partial η}{\partial {x}_{j}} ( \frac{{\partial }^{2} {u}_{i}}{\partial {x}_{j} \partial t} + \frac{{\partial }^{2} {u}_{j}}{\partial {x}_{i} \partial t} ) - \frac{\partial {p}_{0}}{\partial {x}_{i}} ;$$

where ρ is a density, it is default that the density is uniform, and is 1000 kg/m³; uᵢ is displacement in an i direction, t is time, μ is the shear modulus, j is a parameter of Einstein summation convention, xᵢ is a spatial scale in the i direction, xⱼ is a spatial scale of the Einstein summation convention, η is viscosity, uⱼ is displacement of Einstein summation convention, and p₀ is Lagrange multiplier related to an incompressibility constraint.

The Newton's second law is:

$$\frac{\partial {σ}_{ij}}{\partial {x}_{j}} = ρ \frac{{\partial }^{2} {u}_{i}}{\partial {t}^{2}} ,$$

where σᵢⱼ is stress.

The shear stress-shear strain relationship is as follows:

$${σ}_{ij} = μ ( \frac{\partial {u}_{i}}{\partial {x}_{j}} + \frac{\partial {u}_{j}}{\partial {x}_{i}} ) + η ( \frac{{\partial }^{2} {u}_{i}}{\partial {x}_{j} \partial t} + \frac{{\partial }^{2} {u}_{j}}{\partial {x}_{i} \partial t} ) - {p}_{0} {δ}_{ij} ,$$

where δᵢⱼ is Dirac delta function for introducing conditions of incompressibility constraints in the equation.

In step 202, the expression form of a wave equation about the particle displacement for an inhomogeneous medium is arranged as an expression form of particle vibration velocity in a two-dimensional space as follows:

$$\{ \begin{matrix}\begin{matrix}μ ( \frac{{\partial }^{2} {v}_{1}}{\partial {x}_{1}^{2}} + \frac{{\partial }^{2} {v}_{1}}{\partial {x}_{2}^{2}} ) + η ( \frac{{\partial }^{3} {v}_{1}}{\partial {x}_{1}^{2} \partial t} + \frac{{\partial }^{3} {v}_{1}}{\partial {x}_{2}^{2} \partial t} ) + 2 \frac{\partial μ}{\partial {x}_{1}} \frac{\partial {v}_{1}}{\partial {x}_{1}} + \\ \frac{\partial μ}{\partial {x}_{2}} ( \frac{\partial {v}_{1}}{\partial {x}_{2}} + \frac{\partial {v}_{2}}{\partial {x}_{1}} ) + 2 \frac{\partial η}{\partial {x}_{1}} \frac{\partial {v}_{1}^{2}}{\partial {x}_{1} \partial t} + \frac{\partial η}{\partial {x}_{2}} ( \frac{{\partial }^{2} {v}_{1}}{\partial {x}_{2} \partial t} + \frac{{\partial }^{2} {v}_{2}}{\partial {x}_{1} \partial t} ) - {p}_{, 1} - ρ \frac{{\partial }^{2} {v}_{1}}{\partial {t}^{2}} = 0\end{matrix} \\ \begin{matrix}μ ( \frac{{\partial }^{2} {v}_{2}}{\partial {x}_{1}^{2}} + \frac{{\partial }^{2} {v}_{2}}{\partial {x}_{2}^{2}} ) + η ( \frac{{\partial }^{3} {v}_{2}}{\partial {x}_{1}^{2} \partial t} + \frac{{\partial }^{3} {v}_{2}}{\partial {x}_{2}^{2} \partial t} ) + 2 \frac{\partial μ}{\partial {x}_{2}} \frac{\partial {v}_{2}}{\partial {x}_{2}} + \\ \frac{\partial μ}{\partial {x}_{1}} ( \frac{\partial {v}_{1}}{\partial {x}_{2}} + \frac{\partial {v}_{2}}{\partial {x}_{1}} ) + 2 \frac{\partial η}{\partial {x}_{2}} \frac{\partial {v}_{2}^{2}}{\partial {x}_{2} \partial t} + \frac{\partial η}{\partial {x}_{1}} ( \frac{{\partial }^{2} {v}_{2}}{\partial {x}_{1} \partial t} + \frac{{\partial }^{2} {v}_{1}}{\partial {x}_{2} \partial t} ) - {p}_{, 2} - ρ \frac{{\partial }^{2} {v}_{2}}{\partial {t}^{2}} = 0\end{matrix}\end{matrix} , where {v}_{1} is$$

horizontal vibration velocity of particles, v₂ is vertical vibration velocity of particles, x₁ is a physical spatial scale of abscissa, x₂ is a physical spatial scale of ordinate, p_{,1} is a partial derivative of Lagrange operator p that satisfies the incompressibility constraint with respect to a horizontal direction, and p_{,2} is a partial derivative of Lagrange operator p that satisfies the incompressibility constraint with respect to a vertical direction.

By arranging as an expression form of particle vibration velocity in a two-dimensional space, it is convenient for subsequent coding of the expression form into the neural network.

In step 203, the expression form of the particle vibration velocity in the two-dimensional space is simplified by introducing the stream function, to acquire an inhomogeneous viscoelastic wave equation as follows:

$${v}_{1} = \frac{\partial ψ}{\partial {x}_{2}} , {v}_{2} = - \frac{\partial ψ}{\partial {x}_{1}} ,$$

where ψ is a stream function.

To ensure that conditions of incompressibility constraints are always satisfied in the process of solving the equation, the stream function ψ is introduced for further simplification.

In another example embodiment, the elastic inverse estimation technology based on deep learning needs to be driven by massive data. However, due to the difficulties in acquiring clinical SWE datasets and their defects in interpretability and generalizability, it is necessary to develop a physics-informed model that integrate physical laws into the deep learning, which can achieve a prediction result that conforms to the basic physical laws under the driving of less data, and avoid “black box effect”. The physics-informed neural network is an innovative calculation method. By coding control equations of physical problems, such as a partial differential equation, in a fully-connected neural network, the physical laws are regarded as a part of neural network training. This method not only retains the powerful learning ability of a deep learning model, but also combines the laws of physics, making the model more robust and physically explanatory in the face of complex problems. PINN has gradually become an effective tool to solve forward and inverse problems, especially in the case of complex multi-physical field coupling, showing a strong application prospect.

The physics-informed neural network combines powerful modeling ability of deep learning with the constraints of the physical equation, and is gradually becoming a powerful tool to solve the mechanical inverse estimation problem of complex biological tissues. By coding the inhomogeneous viscoelastic wave equation into the physics-informed neural network and inputting a set of vibration velocity data of particles of the shear wave, the spatial distributions of viscosity and shear modulus in the tissue can be solved more accurately. This method not only improves the resolution of small-sized inclusions, but also provides new possibilities for accurate diagnosis of the complex soft tissues.

At present, mature research or applications on viscoelastic estimation in shear wave elastography based on the physics-informed neural network have not yet emerged. However, because the physics-informed neural network can capture physical characteristics in the wave process more accurately by the constraints of the physical equation, this method is expected to overcome many limitations in the prior art. Specifically, the physics-informed neural network can describe the complex situation of shear wave propagation more accurately when dealing with heterogeneous tissues, thereby providing a new solution for accurate estimation of the viscoelastic spatial distribution. With the in-depth study of the physics-informed neural network in this field, it has a potential to significantly improve a clinical application value of the shear wave elastography technology and promote its wide application in precision medicine.

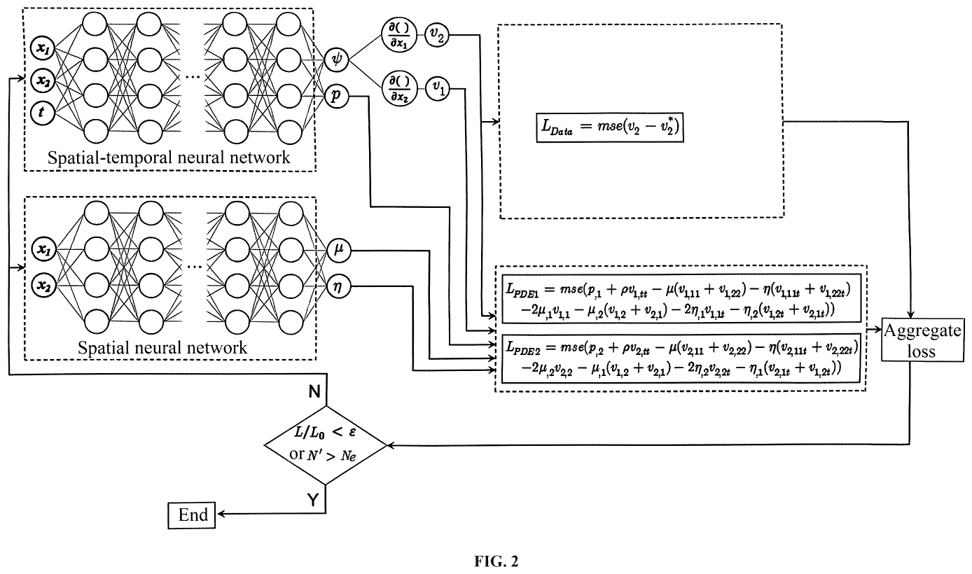

In the present disclosure, the physics-informed neural network is innovatively applied to inverse estimation of the tissue viscoelasticity in the shear wave elastography. As shown in FIG. 2, the physics-informed neural network mainly includes a spatial-temporal neural network and a spatial neural network for respectively solving four unknowns in step 202 and step 203: a stream function ψ, Lagrange operator p that satisfies an incompressibility constraint, shear modulus μ, and viscosity η.

A specific structure of the physics-informed neural network shown in FIG. 2 is as follows.

The spatial-temporal neural network contains three input parameters (x₁, x₂, t) and four hidden layers, and each layer has 80 neurons and two output parameters (the stream function ψ and Lagrange operator p that satisfies the incompressibility constraint), which are used to output partial derivatives of parameters to a three-dimensional space-time coordinate system in the process of backward propagation.

The spatial neural network contains two input parameters (x₁, x₂) and four hidden layers, and each layer has 80 neurons and two output parameters (spatial distributions of viscosity η and shear modulus μ), which are used to output partial derivatives of parameters to a two-dimensional space-time coordinate system in the process of backward propagation.

A loss function of the physics-informed neural network includes a data error loss function and a partial differential equation loss function. The data error loss function is

$${L}_{Data} = mse ( {v}_{2} - {v}_{2}^{*} ) ,$$

where L_{Data} is data error loss, mse is a mean square error, v₂ is vertical vibration velocity of particles, and

$${v}_{2}^{*}$$

is vertical vibration velocity of particles as supervisory data. That is, the mean square error loss (Data Loss) is calculated from the real collected vertical vibration velocity of particles and the vertical vibration velocity of particles output by the network.

The partial differential equation loss (PDE loss) is jointly composed of mse of multi-order partial derivatives output by respective networks, to achieve the coding of inhomogeneous viscoelastic wave equation. The partial differential equation loss function is as follows:

$${L}_{PDE 1} = mse ( {p}_{, 1} + ρ {v}_{1 , tt} - μ ( {v}_{1 , 11} + {v}_{1 , 22} ) - η ( {v}_{1 , 11 t} + {v}_{1 , 22 t} ) - 2 {μ}_{, 1} {v}_{1 , 1} - {μ}_{2} ( {v}_{1 , 2} + {v}_{2 , 1} ) - 2 {η}_{, 1} {v}_{1 , 1 t} - {η}_{, 2} ( {v}_{1 , 2 t} + {v}_{2 , 1 t} ) ) ; and$$

$${L}_{PDE 2} = mse ( {p}_{, 2} + ρ {v}_{2 , tt} - μ ( {v}_{2 , 11} + {v}_{2 , 22} ) - η ( {v}_{2 , 11 t} + {v}_{2 , 22 t} ) - 2 {μ}_{, 2} {v}_{2 , 2} - {μ}_{, 1} ( {v}_{1 , 2} + {v}_{2 , 1} ) - 2 {η}_{2} {v}_{2 , 2 t} - {η}_{, 1} ( {v}_{2 , 1 t} + {v}_{1 , 2 t} ) ) ,$$

where L_{PDE1} is first partial differential equation loss, p_{,1} is a partial derivative of Lagrange operator p that satisfies the incompressibility constraint with respect to a horizontal direction, ρ is a density, v_{1,tt} is a second-order derivative of horizontal vibrational velocity of particle with respect to time, μ is shear modulus, v_{1,11} is a second-order derivative of the horizontal vibration velocity of particles with respect to a horizontal direction, v_{1,22} is a second-order derivative of the horizontal vibration velocity of particles with respect to a vertical direction, η is viscosity, v_{1,11t} is a partial derivative of v_{1,11} with respect to time t after calculating a second-order derivative of the horizontal vibrational velocity of particles with respect to the horizontal direction; v_{1,22t} is a partial derivative of v_{1,22} with respect to time t after calculating a second-order derivative of the horizontal vibrational velocity of particles with respect to the vertical direction, μ_{,1} is a partial derivative of the shear modulus with respect to the horizontal direction, v_{1,1} is a partial derivative of the horizontal vibration velocity of particles with respect to the horizontal direction, μ_{,2} is a partial derivative of the shear modulus with respect to the vertical direction, v_{1,2} is a partial derivative of the horizontal vibration velocity of particles with respect to the vertical direction, v_{2,1} is a partial derivative of the vertical vibration velocity of particles with respect to the horizontal direction, η_{,1} is a partial derivative of the viscosity with respect to the horizontal direction, v_{1,1t} is a partial derivative of v_{1,1} with respect to time t after calculating a partial derivative of the horizontal vibration velocity of particles with respect to the horizontal direction, η_{,2} is a partial derivative of the viscosity with respect to the vertical direction, v_{1,2t} is a partial derivative of v_{1,2} with respect to time t after calculating the partial derivative of the horizontal vibration velocity of particles with respect to the vertical direction, v_{2,1t} is partial derivative of v_{2,1} with respect to time t after calculating the partial derivative of the vertical vibration velocity of particles with respect to the horizontal direction, L_{PDE2} is second partial differential equation loss, v_{2,tt} is a second-order derivative of the vertical vibration velocity of particles with respect to time t, v_{2,11} is second-order derivative of the vertical vibration velocity of particles with respect to the horizontal direction, v_{2,22} is a second-order derivative of the vertical vibration velocity of particles with respect to the vertical direction, v_{2,11t} is a partial derivative of v_{2,11} with respect to time t after calculating a second-order derivative of the vertical vibration velocity of particles with respect to the horizontal direction, v_{2,22t} is a partial derivative of v_{2,22} with respect to time t after calculating a second-order derivative of the vertical vibration velocity of particles with respect to the vertical direction, v_{2,2} is a partial derivative of the vertical vibration velocity of particles with respect to the vertical direction, and v_{2,2t} is a partial derivative of v_{2,2} with respect to time t after calculating a partial derivative of the vertical vibration velocity of particles with respect to the vertical direction.

The loss function is summed by products of the data error loss function and the partial differential equation loss function with their respective hyperparameters, which ensures that the rate of each loss function is consistent in the process of decline, which is beneficial to the convergence of the whole network. The selection of the hyperparameter can be adjusted appropriately according to different use environments. The loss function is as follows: L=λ_{PDE}(L_{PDE1}+L_{PDE2})+λ_{Data}L_{Data}, where L is aggregate loss, λ_{PDE} is a hyperparameter of the partial differential equation loss function, and λ_{Data} is a hyperparameter of the data error loss function.

In another example embodiment of the present disclosure, an activation function of the physics-informed neural network is Hyperbolic Tangent (Tanh) function, but other activation functions such as Rectified Linear Unit (ReLu) may also achieve similar functions. The physics-informed neural network adopts a traditional multi-layer perceptron, that is, only weights of neurons are changed during training, while the activation function is unchanged during training. At present, there is a variable-activation-function strategy, that is, a B-spline function is used, in which the parameters can be updated through the training process, so that the activation function corresponding to each neuron will change continuously with the training process, and the partial differential equation can be solved theoretically, but this method has a requirement for a video memory.

In another example embodiment of the present disclosure, to apply this method to clinical practice better, the physics-informed neural network is pre-trained on the existing data, so that the physics-informed neural network can meet the solution process of the wave equation forcibly, and a gradient descent direction can be found as quickly as possible after the new data is input into the network. After testing, it is found that the pre-trained physics-informed neural network can reduce the training time by more than 80% without reducing the imaging quality, which greatly accelerates the solution speed of inverse estimation and can meet the clinical needs to the greatest extent. Before the step 104, the method further includes: pre-training the physics-informed neural network. For example, to reconstruct viscoelastic SWE data of a liver patient rapidly, a pre-training mode may be as follows: inputting multi-frame vertical vibration velocity of particles of the liver patient into the physics-informed neural network in advance for solution; and taking model parameters after the convergence of the physics-informed neural network pre-training as initialization settings for subsequent solution.

In another example embodiment of the present disclosure, the step 104 may be replaced with steps 301 to 309.

In step 301, time t and a spatial scale (x₁, x₂) are set, where xᵢ is a physical spatial scale of the abscissa, and x₂ is a physical spatial scale of the ordinate.

In step 302, a current predicted stream function p and Lagrange operator p that satisfies the incompressibility constraint are acquired by the spatial-temporal neural network based on the time t and the spatial scale (x₁, x₂).

In step 303, horizontal vibration velocity v₁ of particles and vertical vibration velocity v₂ of particles are calculated by using the inhomogeneous viscoelastic wave equation based on the current predicted stream function ψ.

In step 304, the data error loss is calculated by using the data error loss function in the loss function based on the calculated vertical vibration velocity v₂ of particles and the multi-frame vertical vibration velocity of particles of the object to be measured.

In step 305, a current predicted shear modulus μ and a current predicted viscosity η are acquired by the spatial neural network based on the spatial scale (x₁, x₂).

In step 306, partial differential equation loss is calculated by using the partial differential equation loss function in the loss function based on the current predicted shear modulus μ, the current predicted viscosity η, the horizontal vibration velocity v₁ of particles and the vertical vibration velocity v₂ of particles.

In step 307, current aggregate loss is acquired by combining the partial differential equation loss and the data error loss.

In step 308, if L/L₀≥ε and N′≤Nₑ are satisfied, network parameters of the physics-informed neural network are adjusted, and it is returned to execute the step of acquiring a current predicted stream function ψ and Lagrange operator p that satisfies the incompressibility constraint by the spatial-temporal neural network based on the time t and a spatial scale (x₁, x₂), where L is the current aggregate loss, L₀ is initial loss, ε is a predetermined threshold, N′ is a number of iterations, and Nₑ is a maximum number of iterations.

In step 309, if L/L₀<ε or N′>Nₑ is satisfied, the current predicted shear modulus μ and the current predicted viscosity η are output as spatial distribution of the shear modulus and the spatial distribution of the viscosity of the objected to be measured.

In another example embodiment of the present disclosure, to reduce the motion interference and electronic noise as much as possible, 30 times of superposition averaging are carried out to improve a signal-to-noise ratio. An ultrasonic radio frequency signal collected by the ultrasonic transducer is a modulated wave, which needs to be demodulated according to a central frequency of a probe. In-phase/Quadrature (IQ) demodulation is a common method, and a complex signal is obtained after demodulation, including amplitude and phase information. As an amplitude of the shear wave is often in micron level, the traditional structural imaging is not enough to distinguish such a weak vibration, so it is necessary to track the particle vibration velocity on the basis of IQ data. Considering the computational complexity and stability, a phase-difference-based particle vibration velocity estimation method is selected to calculate a displacement between frames. The central frequency, sound velocity and a time interval between frames of the ultrasonic signal are known, and the particle vibration velocity of these N frames can be calculated by using the phase difference. In this way, the process of determining the multi-frame vertical vibration velocity of particles of the object to be measured in the above step 103 can be replaced with the following steps 401 to 403.

In step 401, the consecutive frames of ultrasonic radio frequency signals of the objected to be measured collected by an ultrasonic transducer are acquired, and subjected to IQ demodulation to acquire a demodulated signal for each frame.

In step 402, particle vibration displacement for each frame is acquired by using a phase-difference-based particle vibration velocity estimation method based on the demodulated signal for each frame.

In step 403, particle vibration velocity for each frame is acquired based on the particle vibration displacement for each frame, where the particle vibration velocity includes the horizontal vibration velocity of particles and the vertical vibration velocity of particles.

According to another example embodiment, a calculation formula of a phase-difference particle vibration velocity estimation method is as follows:

$$\overline{u} = \frac{c}{4 π {f}_{c}} arctan ( \frac{{\sum }_{n = 0}^{N - 2} [ \begin{matrix}{\sum }_{m = 0}^{M - 1} Q ( m , n ) {\sum }_{m = 0}^{M - 1} I ( m , n + 1 ) - \\ {\sum }_{m = 0}^{M - 1} I ( m , n ) {\sum }_{m = 0}^{M - 1} Q ( m , n + 1 )\end{matrix} ]}{{\sum }_{n = 0}^{N - 2} [ \begin{matrix}{\sum }_{m = 0}^{M - 1} I ( m , n ) {\sum }_{m = 0}^{M - 1} I ( m , n + 1 ) + \\ {\sum }_{m = 0}^{M - 1} Q ( m , n ) {\sum }_{m = 0}^{M - 1} Q ( m , n + 1 )\end{matrix} ]} ) ;$$

where ū is particle vibration displacement, c is sound velocity, f_{c} is a central PG frequency, N is a total number of frames, M is a number of rows in IQ data, Q(m, n) is an orthogonal component of an n-th frame in an m-th row of the IQ data, Q (m, n+1) is an orthogonal component of a (n+1)-th frame in the m-th row of the IQ data, I(m, n) is a co-directional component of the n-th frame in the m-th row of the IQ data, and I(m, n+1) is a co-directional component of the (n+1)-th frame in the m-th row of the IQ data. The IQ data is a modulated signal for each frame obtained after performing IQ demodulation.

According to the present disclosure, the spatial distributions of shear modulus and viscosity can be accurately solved through the vibration velocity data of singleton particle. According to the method, the similarity between the back propagation characteristics of the neural network and the chain derivative rule is skillfully utilized, so that the method can effectively achieve the accurate solution of the partial differential equation by using the characteristics of automatic differentiation. A singleton refers to multiple frames of ultrasonic radio frequency signals collected at one time.

The method for measuring ultrasonic viscoelasticity provided by the present disclosure is a method for solving the spatial distribution of tissue viscoelasticity based on the physics-informed neural network, and the beneficial effects of the method of the application are as follows.
1. The present disclosure puts forward an innovative method for the first time, which codes a wave control equation in Kelvin-Voigt model as a loss function, and designs a novel network architecture by using an automatic differential function of the neural network, thereby achieving accurate and fast spatial inverse estimation of viscoelasticity. This method remarkably improves the interpretability of the model and optimizes the efficiency of the inverse estimation process.
2. The method provided by the present disclosure represents a leading partial differential equation (PDE) (including partial derivatives/partial differential equations of unknown functions) solution technology, which does not need a complicated and tedious model training process. It can directly and quickly predict the data of each case, accurately calculate the viscoelastic distribution in line with the wave equation, and show excellent generalization ability.
3. Compared with the traditional ToF method that relies solely on shear wave velocity features, the method of the present disclosure fully utilizes various features of the collected data, effectively avoiding estimation errors caused by scattering or reflection of the transverse wave due to the inhomogeneity of tissues. Therefore, the method provided by the present disclosure is more applicable in complex human environments and can provide a more accurate and reliable diagnostic result.

Based on the same inventive concept, the embodiment of the present disclosure further provides an apparatus for measuring ultrasonic viscoelasticity for implementing the method for measuring ultrasonic viscoelasticity measurement described above. An implemented solution provided by the apparatus for solving the problem is similar to that recorded in the above-mentioned method. Therefore, specific limitations in one or more embodiments of the apparatus for measuring ultrasonic viscoelasticity provided below can be referred to the limitations described above for the method for measuring ultrasonic viscoelasticity, and thus will not be repeated here.

In an example embodiment, an apparatus for measuring ultrasonic viscoelastic is provided, including an equation establishing module, a neural network construction module, a vibration velocity determining module, and an application module. The equation establishing module is configured to establish an inhomogeneous viscoelastic wave equation, where the inhomogeneous viscoelastic wave equation characterizes a relationship between vertical vibration velocity of particles and a stream function. The neural network construction module is configured to code the inhomogeneous viscoelastic wave equation as a loss function and construct a physics-informed neural network, where the physics-informed neural network includes a spatial-temporal neural network, a spatial neural network and the loss function, the spatial-temporal neural network is configured to predict a stream function, the inhomogeneous viscoelastic wave equation is used to obtain the vertical vibration velocity of particles based on the stream function outputted, the spatial neural network is configured to predict shear modulus and viscosity, and the loss function is used to calculate an aggregate loss based on the vertical vibration velocity of particles, the shear modulus and the viscosity. The vibration velocity determining module is configured to determine multi-frame vertical vibration velocity of particles of an object to be measured based on consecutive frames of ultrasonic radio frequency signals of the object to be measured. The application module is configured to input the multi-frame vertical vibration velocity of particles of the object to be measured as supervisory data into the physics-informed neural network, to obtain a spatial distribution of the shear modulus and a spatial distribution of the viscosity of the object to be measured.

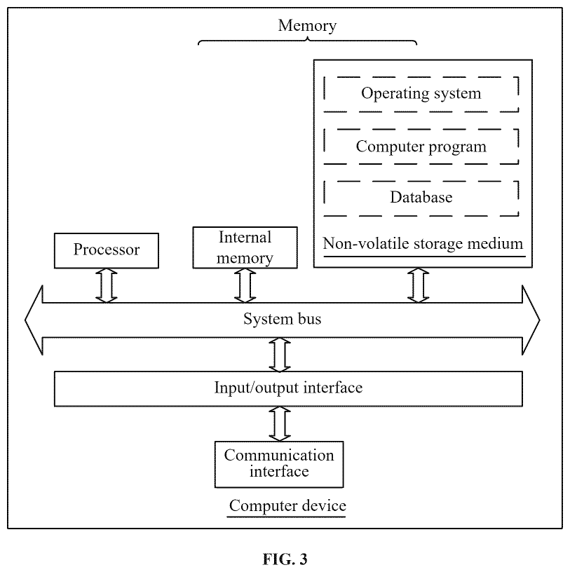

In an example embodiment, a computer device is provided, which may be a server or a terminal, with an internal structural diagram shown in FIG. 3. The computer device includes a processor, a memory, an input/output (I/O) interface, and a communication interface. The processor, the memory and the input/output interface are connected via a system bus, and the communication interface is connected to the system bus via the input/output interface. The processor of the computer device is configured to provide computing and control capabilities. The memory of the computer device includes a non-volatile storage medium, and an internal memory. An operation system, a computer program and a database are arranged in the non-volatile storage medium. The internal memory provides an environment for the running of the operation system and the computer program in the non-volatile storage medium. The database of the computer device is configured to store the spatial distributions of shear modulus and viscosity of the object to be measured. The input/output interface of the computer device is used for exchanging information between the processor and an external device. The communication interface of the computer device is used for communicating with an external terminal over a network. The computer program, when executed by the processor, is configured to implement a method for measuring ultrasonic viscoelasticity.

Those skilled in the art may understand that the structure shown in FIG. 3 is only a block diagram of a part of the structure related to the scheme of the present disclosure, and does not constitute a limitation on the computer device to which the scheme of the present disclosure is applied. The specific computer device may include more or less components than those shown in the figure, or combine some components, or have different component arrangements. In an example embodiment, a computer device is provided, including: a memory, a processor, and a computer program stored in the memory and executable on the processor. The processor, when executing the computer program, is configured to implement steps in the method embodiments above.

In an example embodiment, a computer readable storage medium is further provided, and a computer program is stored on the computer readable storage medium. The computer program, when executed by a processor, is configured to implement the steps in various method embodiments above.

It should be noted that the user information (including, but not limited to, user equipment information, user personal information, etc.) and data (including, but not limited to, data for analysis, stored data, displayed data, etc.) involved in the present disclosure are all information and data authorized by the user or fully authorized by all parties.

Those skilled in the art can understand that all or part of the processes in the method for implementing the foregoing embodiments can be completed by instructing related hardware through a computer program. The computer program can be stored in a non-volatile computer-readable storage medium. When the computer program is executed, the computer program may include the processes of the foregoing method embodiments. Any reference to memory, database or other media used in the embodiments provided in the present disclosure may include at least one of a non-volatile memory and a volatile memory. The non-volatile memory may include a read only memory (ROM), a magnetic tape, a floppy disk, a flash memory, an optical memory, a high-density embedded non-volatile memory, a resistive random access memory (ReRAM), a magnetoresistive random access memory (MRAM), a ferroelectric random access memory (FRAM), a phase change memory (PCM), a graphene memory, etc. The volatile memory may include a random access memory (RAM), or an external cache memory. By way of illustration than limitation, RAM may be in various forms, such as a static random access memory (SRAM) or a dynamic random access memory (DRAM).

The database involved in each embodiment provided by the present disclosure may include at least one of a relational database and a non-relational database. The non-relational database may include, but is not limited to, a distributed database based on blockchain. The processor involved in each embodiment provided by the present disclosure may be, but is not limited to, a general-purpose processor, a central processing unit, a graphics processor, a digital signal processor, a programmable logic unit, a data processing logic unit based on quantum computing, etc.

The technical features of the above embodiments can be combined at will. To make the description concise, not all possible combinations of the technical features in the above embodiments are described. However, it should be considered that these combinations of technical features fall within the scope recorded in this specification provided that these combinations of technical features do not have any conflict.

Specific examples are used herein for illustration of the principles and implementation methods of the present disclosure. The description of the embodiments is merely used to help illustrate the method and its core principles of the present disclosure. In addition, a person of ordinary skill in the art can make various modifications in terms of specific embodiments and scope of application in accordance with the teachings of the present disclosure. In conclusion, the content of this specification shall not be construed as a limitation to the present disclosure.

What is claimed is:

1. A method for measuring ultrasonic viscoelasticity, comprising:
establishing an inhomogeneous viscoelastic wave equation, wherein the inhomogeneous viscoelastic wave equation characterizes a relationship between particle vertical vibration velocity and a stream function;
coding the inhomogeneous viscoelastic wave equation as a loss function, and constructing a physics-informed neural network, wherein the physics-informed neural network comprises a spatial-temporal neural network, a spatial neural network and the loss function, the spatial-temporal neural network is configured to predict the stream function, the inhomogeneous viscoelastic wave equation is used to obtain the particle vertical vibration velocity based on the stream function outputted, the spatial neural network is configured to predict shear modulus and viscosity, and the loss function is used to calculate an aggregate loss based on the particle vertical vibration velocity, the shear modulus and the viscosity;
determining multi-frame particle vertical vibration velocity of an object to be measured based on consecutive frames of ultrasonic radio frequency signals of the object to be measured; and
inputting the multi-frame particle vertical vibration velocity of the object to be measured as supervisory data into the physics-informed neural network, to obtain a spatial distribution of the shear modulus and a spatial distribution of the viscosity of the object to be measured.

2. The method according to claim 1, wherein the establishing an inhomogeneous viscoelastic wave equation comprises:
based on Newton's second law and a shear stress-shear strain relationship, determining an expression form of a wave equation about particle displacement for an inhomogeneous medium as follows:
$$ρ \frac{{\partial }^{2} {u}_{i}}{\partial {t}^{2}} = μ \frac{{\partial }^{2} {u}_{i}}{\partial {x}_{j} \partial {x}_{j}} + η \frac{{\partial }^{3} {u}_{i}}{\partial {x}_{j} \partial {x}_{j} \partial t} + \frac{\partial μ}{\partial {x}_{j}} ( \frac{\partial {u}_{i}}{\partial {x}_{j}} + \frac{\partial {u}_{j}}{\partial {x}_{i}} ) + \frac{\partial η}{\partial {x}_{j}} ( \frac{{\partial }^{2} {u}_{i}}{\partial {x}_{j} \partial t} + \frac{{\partial }^{2} {u}_{j}}{\partial {x}_{i} \partial t} ) - \frac{\partial {p}_{0}}{\partial {x}_{i}} ,$$
where ρ is a density, uᵢ is displacement in an i direction, t is time, μ is the shear modulus, j is a parameter of Einstein summation convention, xⱼ is a spatial direction, η is the viscosity, uⱼ is displacement of the Einstein summation convention, and p₀ is Lagrange multiplier related to an incompressibility constraint;
arranging the expression form of the wave equation about the particle displacement for the inhomogeneous medium as an expression form of particle vibration velocity in a two-dimensional space as follows:
$$\{ \begin{matrix}\begin{matrix}μ ( \frac{{\partial }^{2} {v}_{1}}{\partial {x}_{1}^{2}} + \frac{{\partial }^{2} {v}_{1}}{\partial {x}_{2}^{2}} ) + η ( \frac{{\partial }^{3} {v}_{1}}{\partial {x}_{1}^{2} \partial t} + \frac{{\partial }^{3} {v}_{1}}{\partial {x}_{2}^{2} \partial t} ) + 2 \frac{\partial μ}{\partial {x}_{1}} \frac{\partial {v}_{1}}{\partial {x}_{1}} + \\ \frac{\partial μ}{\partial {x}_{2}} ( \frac{\partial {v}_{1}}{\partial {x}_{2}} + \frac{\partial {v}_{2}}{\partial {x}_{1}} ) + 2 \frac{\partial η}{\partial {x}_{1}} \frac{\partial {v}_{1}^{2}}{\partial {x}_{1} \partial t} + \frac{\partial η}{\partial {x}_{2}} ( \frac{{\partial }^{2} {v}_{1}}{\partial {x}_{2} \partial t} + \frac{{\partial }^{2} {v}_{2}}{\partial {x}_{1} \partial t} ) - {p}_{, 1} - ρ \frac{{\partial }^{2} {v}_{1}}{\partial {t}^{2}} = 0\end{matrix} \\ \begin{matrix}μ ( \frac{{\partial }^{2} {v}_{2}}{\partial {x}_{1}^{2}} + \frac{{\partial }^{2} {v}_{2}}{\partial {x}_{2}^{2}} ) + η ( \frac{{\partial }^{3} {v}_{2}}{\partial {x}_{1}^{2} \partial t} + \frac{{\partial }^{3} {v}_{2}}{\partial {x}_{2}^{2} \partial t} ) + 2 \frac{\partial μ}{\partial {x}_{2}} \frac{\partial {v}_{2}}{\partial {x}_{2}} + \\ \frac{\partial μ}{\partial {x}_{1}} ( \frac{\partial {v}_{1}}{\partial {x}_{2}} + \frac{\partial {v}_{2}}{\partial {x}_{1}} ) + 2 \frac{\partial η}{\partial {x}_{2}} \frac{\partial {v}_{2}^{2}}{\partial {x}_{2} \partial t} + \frac{\partial η}{\partial {x}_{1}} ( \frac{{\partial }^{2} {v}_{2}}{\partial {x}_{1} \partial t} + \frac{{\partial }^{2} {v}_{1}}{\partial {x}_{2} \partial t} ) - {p}_{, 2} - ρ \frac{{\partial }^{2} {v}_{2}}{\partial {t}^{2}} = 0\end{matrix}\end{matrix} , where {v}_{1}$$
is particle horizontal vibration velocity, v₂ is the particle vertical vibration velocity, x₁ is a physical spatial scale of abscissa, x₂ is a physical spatial scale of ordinate, p_{,1} is a partial derivative of Lagrange operator p that satisfies the incompressibility constraint with respect to a horizontal direction, and p_{,2} is a partial derivative of the Lagrange operator p that satisfies the incompressibility constraint with respect to a vertical direction; and
simplifying the expression form of the particle vibration velocity in the two-dimensional space by introducing the stream function, to acquire the inhomogeneous viscoelastic wave equation as follows:
$${v}_{1} = \frac{\partial ψ}{\partial {x}_{2}} , {v}_{2} = - \frac{\partial ψ}{\partial {x}_{1}} ,$$
where ψ is the stream function.

3. The method according to claim 1, wherein the loss function comprises a data error loss function, and a partial differential equation loss function; wherein
the data error loss function is
$${L}_{Data} = mse ( {v}_{2} - {v}_{2}^{*} ) ,$$
where L_{Data} is data error loss, mse is mean square error, v₂ is the particle vertical vibration velocity, and
$${v}_{2}^{*}$$
is a particle vertical vibration velocity serving as the supervisory data;
the partial differential equation loss function is as follows:
$${L}_{PDE 1} = mse ( {p}_{, 1} + ρ {v}_{1 , tt} - μ ( {v}_{1 , 11} + {v}_{1 , 22} ) - η ( {v}_{1 , 11 t} + {v}_{1 , 22 t} ) - 2 {μ}_{, 1} {v}_{1 , 1} - {μ}_{, 2} ( {v}_{1 , 2} + {v}_{2 , 1} ) - 2 {η}_{, 1} {v}_{1 , 1 t} - {η}_{, 2} ( {v}_{1 , 2 t} + {v}_{2 , 1 t} ) ) ; and$$
$${L}_{PDE 2} = mse ( {p}_{, 2} + ρ {v}_{2 , tt} - μ ( {v}_{2 , 11} + {v}_{2 , 22} ) - η ( {v}_{2 , 11 t} + {v}_{2 , 22 t} ) - 2 {μ}_{, 2} {v}_{2 , 2} - {μ}_{, 1} ( {v}_{1 , 2} + {v}_{2 , 1} ) - 2 {η}_{, 2} {v}_{2 , 2 t} - {η}_{, 1} ( {v}_{2 , 1 t} + {v}_{1 , 2 t} ) ) ;$$
where L_{PDE1} is first partial differential equation loss, p_{,1} is a partial derivative of Lagrange operator p that satisfies an incompressibility constraint with respect to a horizontal direction, ρ is a density, v_{1,tt} is a second-order derivative of horizontal vibrational velocity of the particle with respect to time, μ is the shear modulus, v_{1,11} is a second-order derivative of the particle horizontal vibration velocity with respect to a horizontal direction, v_{1,22} is a second-order derivative of the particle horizontal vibration velocity with respect to a vertical direction, η is the viscosity, v_{1,11t} is a partial derivative of v_{1,11} with respect to time t after calculating the second-order derivative of the horizontal vibrational velocity of the particle with respect to the horizontal direction; v_{1,22t} is a partial derivative of v_{1,22} with respect to time t after calculating the second-order derivative of the horizontal vibrational velocity of the particles with respect to the vertical direction, μ_{,t} is a partial derivative of the shear modulus with respect to the horizontal direction, v_{1,1} is a partial derivative of the particle horizontal vibration velocity with respect to the horizontal direction, μ_{,2} is a partial derivative of the shear modulus with respect to the vertical direction, v_{1,2} is a partial derivative of the particle horizontal vibration velocity with respect to the vertical direction, v_{2,1} is a partial derivative of the particle vertical vibration velocity with respect to the horizontal direction, η_{,1} is a partial derivative of the viscosity with respect to the horizontal direction, v_{1,1t} is a partial derivative of v_{1,1} with respect to time t after calculating the partial derivative of the particle horizontal vibration velocity with respect to the horizontal direction, η_{,2} is a partial derivative of the viscosity with respect to the vertical direction, v_{1,2t} is a partial derivative of v_{1,2} with respect to time t after calculating the partial derivative of the particle horizontal vibration velocity with respect to the vertical direction, v_{2,1t} is partial derivative of v_{2,1} with respect to time t after calculating the partial derivative of the particle vertical vibration velocity with respect to the horizontal direction, L_{PDE2} is second partial differential equation loss, v_{2,tt} is a second-order derivative of the particle vertical vibration velocity with respect to time t, v_{2,11} is second-order derivative of the particle vertical vibration velocity with respect to the horizontal direction, v_{2,22} is a second-order derivative of the particle vertical vibration velocity with respect to the vertical direction, v_{2,11t} is a partial derivative of v_{2,11} with respect to time t after calculating the second-order derivative of the particle vertical vibration velocity with respect to the horizontal direction, v_{2,22t} is a partial derivative of v_{2,22} with respect to time t after calculating the second-order derivative of the particle vertical vibration velocity with respect to the vertical direction, v_{2,2} is a partial derivative of the particle vertical vibration velocity with respect to the vertical direction, and v_{2,2t} is a partial derivative of v_{2,2} with respect to time t after calculating the partial derivative of the particle vertical vibration velocity with respect to the vertical direction; and
the loss function is L=λ_{PDE} (L_{PDE1}+L_{PDE2})+λ_{Data}L_{Data}, where L is the aggregate loss, λ_{PDE} is a hyperparameter of the partial differential equation loss function, and λ_{Data} is a hyperparameter of the data error loss function.

4. The method according to claim 1, wherein the inputting the multi-frame particle vertical vibration velocity of the object to be measured as supervisory data into the physics-informed neural network, to obtain a spatial distribution of the shear modulus and a spatial distribution of the viscosity of the object to be measured comprises:
setting time t and a spatial scale (x₁, x₂), wherein x₁ is a physical spatial scale of abscissa, and x₂ is a physical spatial scale of ordinate;
acquiring a current predicted stream function ψ and Lagrange operator p that satisfies an incompressibility constraint by the spatial-temporal neural network based on the time t and the spatial scale (x₁, x₂);
calculating particle horizontal vibration velocity v₁ and particle vertical vibration velocity v₂ by using the inhomogeneous viscoelastic wave equation based on the current predicted stream function ψ;
calculating data error loss by using a data error loss function in the loss function based on the calculated particle vertical vibration velocity v₂ and the multi-frame particle vertical vibration velocity of the object to be measured;
acquiring a current predicted shear modulus μ and a current predicted viscosity η by the spatial neural network based on the spatial scale (x₁, x₂);
calculating partial differential equation loss by using a partial differential equation loss function in the loss function based on the current predicted shear modulus μ, the current predicted viscosity η, the particle horizontal vibration velocity v₁ and the particle vertical vibration velocity v₂;
acquiring current aggregate loss by combining the partial differential equation loss and the data error loss;
adjusting network parameters of the physics-informed neural network in response to L/L₀≥ε and N′≤Nₑ being satisfied, and returning to the acquiring a current predicted stream function ψ and Lagrange operator p that satisfies an incompressibility constraint by the spatial-temporal neural network based on the time t and the spatial scale (x₁, x₂) for repeating, wherein L is the current aggregate loss, L₀ is initial loss, ε is a predetermined threshold, N′ is a number of iterations, and Nₑ is a maximum number of iterations; and
outputting the current predicted shear modulus μ and the current predicted viscosity η as the spatial distribution of the shear modulus and the spatial distribution of the viscosity of the object to be measured in response to L/L₀<ε or N′>Nₑ being satisfied.

5. The method according to claim 1, further comprising: before the inputting the multi-frame particle vertical vibration velocity of the object to be measured as supervisory data into the physics-informed neural network, to obtain a spatial distribution of the shear modulus and a spatial distribution of the viscosity of the object to be measured,
pre-training the physics-informed neural network.

6. The method according to claim 1, wherein the determining multi-frame particle vertical vibration velocity of an object to be measured based on consecutive frames of ultrasonic radio frequency signals of the object to be measured comprises:
acquiring the consecutive frames of ultrasonic radio frequency signals of the object to be measured collected by an ultrasonic transducer, and performing In-phase/Quadrature(IQ) demodulation on the consecutive frames of ultrasonic radio frequency signals of the object to be measured to acquire a demodulated signal for each frame;
acquiring particle vibration displacement for each frame by using a phase-difference-based particle vibration velocity estimation method based on the demodulated signal for each frame; and
acquiring particle vibration velocity for each frame based on the particle vibration displacement for each frame, wherein the particle vibration velocity comprises particle horizontal vibration velocity and the particle vertical vibration velocity.

7. The method according to claim 6, wherein a calculating formula of the phase-difference-based particle vibration velocity estimation method is as follows:
$$\overline{u} = \frac{c}{4 π {f}_{c}} arc tan ( \frac{{\sum }_{n = 0}^{N - 2} [ {\sum }_{m = 0}^{M - 1} Q ( m , n ) {\sum }_{m = 0}^{M - 1} I ( m , n + 1 ) - {\sum }_{m = 0}^{M - 1} I ( m , n ) {\sum }_{m = 0}^{M - 1} Q ( m , n + 1 ) ]}{{\sum }_{n = 0}^{N - 2} [ {\sum }_{m = 0}^{M - 1} I ( m , n ) {\sum }_{m = 0}^{M - 1} I ( m , n + 1 ) + {\sum }_{m = 0}^{M - 1} Q ( m , n ) {\sum }_{m = 0}^{M - 1} Q ( m , n + 1 ) ]} ) ;$$
where ū is particle vibration displacement, c is sound velocity, f_{c} is a central frequency, N is a total number of frames, M is a number of rows in IQ data, Q(m, n) is an orthogonal component of an n-th frame in an m-th row of the IQ data, Q(m, n+1) is an orthogonal component of a (n+1)-th frame in the m-th row of the IQ data, I(m, n) is a co-directional component of the n-th frame in the m-th row of the IQ data, and I(m, n+1) is a co-directional component of the (n+1)-th frame in the m-th row of the IQ data.

8. An apparatus for measuring ultrasonic viscoelasticity, comprising:
an equation establishing module, configured to establish an inhomogeneous viscoelastic wave equation, wherein the inhomogeneous viscoelastic wave equation characterizes a relationship between particle vertical vibration velocity and a stream function;
a neural network construction module, configured to code the inhomogeneous viscoelastic wave equation as a loss function and construct a physics-informed neural network, wherein the physics-informed neural network comprises a spatial-temporal neural network, a spatial neural network and the loss function, the spatial-temporal neural network is configured to predict the stream function, the inhomogeneous viscoelastic wave equation is used to obtain the particle vertical vibration velocity based on the stream function outputted, the spatial neural network is configured to predict shear modulus and viscosity, and the loss function is used to calculate an aggregate loss based on the particle vertical vibration velocity, the shear modulus and the viscosity;
a vibration velocity determining module, configured to determine multi-frame particle vertical vibration velocity of an object to be measured based on consecutive frames of ultrasonic radio frequency signals of the object to be measured; and
an application module, configured to input the multi-frame particle vertical vibration velocity of the object to be measured as supervisory data into the physics-informed neural network, to obtain a spatial distribution of the shear modulus and a spatial distribution of the viscosity of the object to be measured.

9. A computer device, comprising:
a memory,
a processor, and
a computer program, stored in the memory and executable on the processor, wherein
the processor is configured to execute the computer program to implement a method, wherein
the method comprises:
establishing an inhomogeneous viscoelastic wave equation, wherein the inhomogeneous viscoelastic wave equation characterizes a relationship between particle vertical vibration velocity and a stream function;
coding the inhomogeneous viscoelastic wave equation as a loss function, and constructing a physics-informed neural network, wherein the physics-informed neural network comprises a spatial-temporal neural network, a spatial neural network and the loss function, the spatial-temporal neural network is configured to predict the stream function, the inhomogeneous viscoelastic wave equation is used to obtain the particle vertical vibration velocity based on the stream function outputted, the spatial neural network is configured to predict shear modulus and viscosity, and the loss function is used to calculate an aggregate loss based on the particle vertical vibration velocity, the shear modulus and the viscosity;
determining multi-frame particle vertical vibration velocity of an object to be measured based on consecutive frames of ultrasonic radio frequency signals of the object to be measured; and
inputting the multi-frame particle vertical vibration velocity of the object to be measured as supervisory data into the physics-informed neural network, to obtain a spatial distribution of the shear modulus and a spatial distribution of the viscosity of the object to be measured.

10. The computer device according to claim 9, wherein the establishing an inhomogeneous viscoelastic wave equation comprises:
based on Newton's second law and a shear stress-shear strain relationship, determining an expression form of a wave equation about particle displacement for an inhomogeneous medium as follows:
$$ρ \frac{{\partial }^{2} {u}_{i}}{\partial {t}^{2}} = μ \frac{{\partial }^{2} {u}_{i}}{\partial {x}_{j} \partial {x}_{j}} + η \frac{{\partial }^{2} {u}_{i}}{\partial {x}_{j} \partial {x}_{j} {\partial }_{t}} + \frac{\partial μ}{\partial {x}_{j}} ( \frac{\partial {μ}_{i}}{\partial {x}_{j}} + \frac{\partial {μ}_{j}}{\partial {x}_{i}} ) + \frac{\partial η}{\partial {x}_{j}} ( \frac{{\partial }^{2} {u}_{i}}{\partial {x}_{j} \partial t} + \frac{{\partial }^{2} {u}_{j}}{\partial {x}_{i} \partial t} ) - \frac{\partial {p}_{0}}{\partial {x}_{i}} ,$$
where ρ is a density, uᵢ is displacement in an i direction, t is time, μ is the shear modulus, j is a parameter of Einstein summation convention, xⱼ is a spatial direction, η is the viscosity, uⱼ is displacement of the Einstein summation convention, and p₀ is Lagrange multiplier related to an incompressibility constraint;
arranging the expression form of the wave equation about the particle displacement for the inhomogeneous medium as an expression form of particle vibration velocity in a two-dimensional space as follows:
$$\{ \begin{matrix}μ ( \frac{{\partial }^{2} {v}_{1}}{\partial {x}_{1}^{2}} + \frac{{\partial }^{2} {v}_{1}}{\partial {x}_{2}^{2}} ) + η ( \frac{{\partial }^{3} {v}_{1}}{\partial {x}_{1}^{2} \partial t} + \frac{{\partial }^{3} {v}_{1}}{\partial {x}_{2}^{2} \partial t} ) + 2 \frac{\partial μ}{\partial {x}_{1}} \frac{\partial {v}_{1}}{\partial {x}_{1}} + \frac{\partial μ}{\partial {x}_{2}} ( \frac{\partial {v}_{1}}{\partial {x}_{2}} + \frac{\partial {v}_{2}}{\partial {x}_{1}} ) + 2 \frac{\partial η}{\partial {x}_{1}} \frac{\partial {v}_{1}^{2}}{\partial {x}_{1} \partial t} + \frac{\partial η}{\partial {x}_{2}} ( \frac{{\partial }^{2} {v}_{1}}{\partial {x}_{2} \partial t} + \frac{{\partial }^{2} {v}_{2}}{\partial {x}_{1} \partial t} ) - {p}_{, 1} - ρ \frac{{\partial }^{2} {v}_{1}}{\partial {t}^{2}} = 0 \\ μ ( \frac{{\partial }^{2} {v}_{2}}{\partial {x}_{1}^{2}} + \frac{{\partial }^{2} {v}_{2}}{\partial {x}_{2}^{2}} ) + η ( \frac{{\partial }^{3} {v}_{2}}{\partial {x}_{1}^{2} \partial t} + \frac{{\partial }^{3} {v}_{2}}{\partial {x}_{2}^{2} \partial t} ) + 2 \frac{\partial μ}{\partial {x}_{2}} \frac{\partial {v}_{2}}{\partial {x}_{2}} + \frac{\partial μ}{\partial {x}_{1}} ( \frac{\partial {v}_{1}}{\partial {x}_{2}} + \frac{\partial {v}_{2}}{\partial {x}_{1}} ) + 2 \frac{\partial η \partial {v}_{2}^{2}}{\partial {x}_{2} \partial {x}_{2} \partial t} + \frac{\partial η}{\partial {x}_{1}} ( \frac{{\partial }^{2} {v}_{2}}{\partial {x}_{1} \partial t} + \frac{{\partial }^{2} {v}_{1}}{\partial {x}_{2} \partial t} ) - {p}_{, 2} - ρ \frac{{\partial }^{2} {v}_{2}}{\partial {t}^{2}} = 0\end{matrix} , where {v}_{1}$$
is particle horizontal vibration velocity, v₂ is the particle vertical vibration velocity, x₁ is a physical spatial scale of abscissa, x₂ is a physical spatial scale of ordinate, p_{,1} is a partial derivative of Lagrange operator p that satisfies the incompressibility constraint with respect to a horizontal direction, and p_{,2} is a partial derivative of the Lagrange operator p that satisfies the incompressibility constraint with respect to a vertical direction; and
simplifying the expression form of the particle vibration velocity in the two-dimensional space by introducing the stream function, to acquire the inhomogeneous viscoelastic wave equation as follows:
$${v}_{1} = \frac{\partial ψ}{\partial {x}_{2}} , {v}_{2} = - \frac{\partial ψ}{\partial {x}_{1}} ,$$
where ψ is the stream function.

11. The computer device according to claim 9, wherein the loss function comprises a data error loss function, and a partial differential equation loss function; wherein
the data error loss function is
$${L}_{Data} = m s e ( {v}_{2} - {v}_{2}^{*} ) ,$$
where L_{Data} is data error loss, mse is mean square error, v₂ is the particle vertical vibration velocity, and
$${v}_{2}^{*}$$
is a particle vertical vibration velocity serving as the supervisory data;
the partial differential equation loss function is as follows:
$${L}_{PDE 1} = mse ( {p}_{, 1} + ρ {v}_{1 , tt} - μ ( {v}_{1 , 11} + {v}_{1 , 22} ) - η ( {v}_{1 , 11 t} + {v}_{1 , 22 t} ) - 2 {μ}_{, 1} {v}_{1 , 1} - {μ}_{, 2} ( {v}_{1 , 2} + {v}_{2 , 1} ) - 2 {η}_{, 1} {v}_{1 , 1 t} - {η}_{, 2} ( {v}_{1 , 2 t} + {v}_{2 , 1 t} ) ) ; and$$
$${L}_{PDE 2} = mse ( {p}_{, 2} + ρ {v}_{2 , tt} - μ ( {v}_{2 , 11} + {v}_{2 , 22} ) - η ( {v}_{2 , 11 t} + {v}_{2 , 22 t} ) - 2 {μ}_{, 2} {v}_{2 , 2} - {μ}_{, 1} ( {v}_{1 , 2} + {v}_{2 , 1} ) - 2 {η}_{, 2} {v}_{2 , 2 t} - {η}_{, 1} ( {v}_{2 , 1 t} + {v}_{1 , 2 t} ) ) ;$$
where L_{PDE1} is first partial differential equation loss, p_{,1} is a partial derivative of Lagrange operator p that satisfies an incompressibility constraint with respect to a horizontal direction, ρ is a density, v_{1,tt} is a second-order derivative of horizontal vibrational velocity of the particle with respect to time, μ is the shear modulus, v_{1,1} is a second-order derivative of the particle horizontal vibration velocity with respect to a horizontal direction, v_{1,22} is a second-order derivative of the particle horizontal vibration velocity with respect to a vertical direction, η is the viscosity, v_{1,1t} is a partial derivative of v_{1,11} with respect to time t after calculating the second-order derivative of the horizontal vibrational velocity of the particle with respect to the horizontal direction; v_{1,22t} is a partial derivative of v_{1,22} with respect to time t after calculating the second-order derivative of the horizontal vibrational velocity of the particles with respect to the vertical direction, μ_{,2} is a partial derivative of the shear modulus with respect to the horizontal direction, v_{1,1} is a partial derivative of the particle horizontal vibration velocity with respect to the horizontal direction, μ_{,2} is a partial derivative of the shear modulus with respect to the vertical direction, v_{1,2} is a partial derivative of the particle horizontal vibration velocity with respect to the vertical direction, v_{2,1} is a partial derivative of the particle vertical vibration velocity with respect to the horizontal direction, η_{,1} is a partial derivative of the viscosity with respect to the horizontal direction, v_{1,1t} is a partial derivative of v_{1,1} with respect to time t after calculating the partial derivative of the particle horizontal vibration velocity with respect to the horizontal direction, η_{,2} is a partial derivative of the viscosity with respect to the vertical direction, v_{1,2t} is a partial derivative of v_{1,2} with respect to time t after calculating the partial derivative of the particle horizontal vibration velocity with respect to the vertical direction, v_{2,1t} is partial derivative of v_{2,1} with respect to time t after calculating the partial derivative of the particle vertical vibration velocity with respect to the horizontal direction, L_{PDE2} is second partial differential equation loss, v_{2,tt} is a second-order derivative of the particle vertical vibration velocity with respect to time t, v_{2,11} is second-order derivative of the particle vertical vibration velocity with respect to the horizontal direction, v_{2,22} is a second-order derivative of the particle vertical vibration velocity with respect to the vertical direction, v_{2,11t} is a partial derivative of v_{2,11} with respect to time t after calculating the second-order derivative of the particle vertical vibration velocity with respect to the horizontal direction, v_{2,22t} is a partial derivative of v_{2,22} with respect to time t after calculating the second-order derivative of the particle vertical vibration velocity with respect to the vertical direction, v_{2,2} is a partial derivative of the particle vertical vibration velocity with respect to the vertical direction, and v_{2,2t} is a partial derivative of v_{2,2} with respect to time t after calculating the partial derivative of the particle vertical vibration velocity with respect to the vertical direction; and
the loss function is L=λ_{PDE} (L_{PDE1}+L_{PDE2}+λ_{Data}L_{Data}, where L is the aggregate loss, λ_{PDE} is a hyperparameter of the partial differential equation loss function, and λ_{Data} is a hyperparameter of the data error loss function.

12. The computer device according to claim 9, wherein the inputting the multi-frame particle vertical vibration velocity of the object to be measured as supervisory data into the physics-informed neural network, to obtain a spatial distribution of the shear modulus and a spatial distribution of the viscosity of the object to be measured comprises:
setting time t and a spatial scale (x₁, x₂), wherein x₁ is a physical spatial scale of abscissa, and x₂ is a physical spatial scale of ordinate;
acquiring a current predicted stream function ψ and Lagrange operator p that satisfies an incompressibility constraint by the spatial-temporal neural network based on the time t and the spatial scale (x₁, x₂);
calculating particle horizontal vibration velocity v₁ and particle vertical vibration velocity v₂ by using the inhomogeneous viscoelastic wave equation based on the current predicted stream function ψ;
calculating data error loss by using a data error loss function in the loss function based on the calculated particle vertical vibration velocity v₂ and the multi-frame particle vertical vibration velocity of the object to be measured;
acquiring a current predicted shear modulus μ and a current predicted viscosity η by the spatial neural network based on the spatial scale (x₁, x₂);
calculating partial differential equation loss by using a partial differential equation loss function in the loss function based on the current predicted shear modulus μ, the current predicted viscosity η, the particle horizontal vibration velocity v₁ and the particle vertical vibration velocity v₂;
acquiring current aggregate loss by combining the partial differential equation loss and the data error loss;
adjusting network parameters of the physics-informed neural network in response to L/L₀≥ε and N′≤Nₑ being satisfied, and returning to the acquiring a current predicted stream function ψ and Lagrange operator p that satisfies an incompressibility constraint by the spatial-temporal neural network based on the time t and the spatial scale (x₁, x₂) for repeating, wherein L is the current aggregate loss, L₀ is initial loss, ε is a predetermined threshold, N′ is a number of iterations, and Nₑ is a maximum number of iterations; and
outputting the current predicted shear modulus μ and the current predicted viscosity η as the spatial distribution of the shear modulus and the spatial distribution of the viscosity of the object to be measured in response to L/L₀≤ε or N′>Nₑ being satisfied.

13. The computer device according to claim 9, further comprising: before the inputting the multi-frame particle vertical vibration velocity of the object to be measured as supervisory data into the physics-informed neural network, to obtain a spatial distribution of the shear modulus and a spatial distribution of the viscosity of the object to be measured,
pre-training the physics-informed neural network.

14. The computer device according to claim 9, wherein the determining multi-frame particle vertical vibration velocity of an object to be measured based on consecutive frames of ultrasonic radio frequency signals of the object to be measured comprises:
acquiring the consecutive frames of ultrasonic radio frequency signals of the object to be measured collected by an ultrasonic transducer, and performing In-phase/Quadrature(IQ) demodulation on the consecutive frames of ultrasonic radio frequency signals of the object to be measured to acquire a demodulated signal for each frame;
acquiring particle vibration displacement for each frame by using a phase-difference-based particle vibration velocity estimation method based on the demodulated signal for each frame; and
acquiring particle vibration velocity for each frame based on the particle vibration displacement for each frame, wherein the particle vibration velocity comprises particle horizontal vibration velocity and the particle vertical vibration velocity.

15. The computer device according to claim 14, wherein a calculating formula of the phase-difference-based particle vibration velocity estimation method is as follows:
$$\overline{u} = \frac{c}{4 π {f}_{c}} arc tan ( \frac{{\sum }_{n = 0}^{N - 2} [ {\sum }_{m = 0}^{M - 1} Q ( m , n ) {\sum }_{m = 0}^{M - 1} I ( m , n + 1 ) - {\sum }_{m = 0}^{M - 1} I ( m , n ) {\sum }_{m = 0}^{M - 1} Q ( m , n + 1 ) ]}{{\sum }_{n = 0}^{N - 2} [ {\sum }_{m = 0}^{M - 1} I ( m , n ) {\sum }_{m = 0}^{M - 1} I ( m , n + 1 ) + {\sum }_{m = 0}^{M - 1} Q ( m , n ) {\sum }_{m = 0}^{M - 1} Q ( m , n + 1 ) ]} ) ;$$
where ū is particle vibration displacement, c is sound velocity, f_{c} is a central frequency, N is a total number of frames, M is a number of rows in IQ data, Q(m, n) is an orthogonal component of an n-th frame in an m-th row of the IQ data, Q(m, n+1) is an orthogonal component of a (n+1)-th frame in the m-th row of the IQ data, I(m, n) is a co-directional component of the n-th frame in the m-th row of the IQ data, and I(m, n+1) is a co-directional component of the (n+1)-th frame in the m-th row of the IQ data.

16. A non-transitory computer readable storage medium, having a computer program stored thereon, wherein the computer program, when executed by a processor, implement the method according to claim 1.

17. The non-transitory computer readable storage medium according to claim 16, wherein the establishing an inhomogeneous viscoelastic wave equation comprises:
based on Newton's second law and a shear stress-shear strain relationship, determining an expression form of a wave equation about particle displacement for an inhomogeneous medium as follows:
$$ρ \frac{{\partial }^{2} {u}_{i}}{\partial {t}^{2}} = μ \frac{{\partial }^{2} {u}_{i}}{\partial {x}_{j} \partial {x}_{j}} + η \frac{{\partial }^{2} {u}_{i}}{\partial {x}_{j} \partial {x}_{j} {\partial }_{t}} + \frac{\partial μ}{\partial {x}_{j}} ( \frac{\partial {μ}_{i}}{\partial {x}_{j}} + \frac{\partial {μ}_{j}}{\partial {x}_{i}} ) + \frac{\partial η}{\partial {x}_{j}} ( \frac{{\partial }^{2} {u}_{i}}{\partial {x}_{j} \partial t} + \frac{{\partial }^{2} {u}_{j}}{\partial {x}_{i} \partial t} ) - \frac{\partial {p}_{0}}{\partial {x}_{i}} ,$$
where ρ is a density, uᵢ is displacement in an i direction, t is time, μ is the shear modulus, j is a parameter of Einstein summation convention, xⱼ is a spatial direction, ij is the viscosity, uⱼ is displacement of the Einstein summation convention, and p₀ is Lagrange multiplier related to an incompressibility constraint;
arranging the expression form of the wave equation about the particle displacement for the inhomogeneous medium as an expression form of particle vibration velocity in a two-dimensional space as follows:
$$\{ \begin{matrix}μ ( \frac{{\partial }^{2} {v}_{1}}{\partial {x}_{1}^{2}} + \frac{{\partial }^{2} {v}_{1}}{\partial {x}_{2}^{2}} ) + η ( \frac{{\partial }^{3} {v}_{1}}{\partial {x}_{1}^{2} \partial t} + \frac{{\partial }^{3} {v}_{1}}{\partial {x}_{2}^{2} \partial t} ) + 2 \frac{\partial μ}{\partial {x}_{1}} \frac{\partial {v}_{1}}{\partial {x}_{1}} + \frac{\partial μ}{\partial {x}_{2}} ( \frac{\partial {v}_{1}}{\partial {x}_{2}} + \frac{\partial {v}_{2}}{\partial {x}_{1}} ) + 2 \frac{\partial η}{\partial {x}_{1}} \frac{\partial {v}_{1}^{2}}{\partial {x}_{1} \partial t} + \frac{\partial η}{\partial {x}_{2}} ( \frac{{\partial }^{2} {v}_{1}}{\partial {x}_{2} \partial t} + \frac{{\partial }^{2} {v}_{2}}{\partial {x}_{1} \partial t} ) - {p}_{, 1} - ρ \frac{{\partial }^{2} {v}_{1}}{\partial {t}^{2}} = 0 \\ μ ( \frac{{\partial }^{2} {v}_{2}}{\partial {x}_{1}^{2}} + \frac{{\partial }^{2} {v}_{2}}{\partial {x}_{2}^{2}} ) + η ( \frac{{\partial }^{3} {v}_{2}}{\partial {x}_{1}^{2} \partial t} + \frac{{\partial }^{3} {v}_{2}}{\partial {x}_{2}^{2} \partial t} ) + 2 \frac{\partial μ}{\partial {x}_{2}} \frac{\partial {v}_{2}}{\partial {x}_{2}} + \frac{\partial μ}{\partial {x}_{1}} ( \frac{\partial {v}_{1}}{\partial {x}_{2}} + \frac{\partial {v}_{2}}{\partial {x}_{1}} ) + 2 \frac{\partial η \partial {v}_{2}^{2}}{\partial {x}_{2} \partial {x}_{2} \partial t} + \frac{\partial η}{\partial {x}_{1}} ( \frac{{\partial }^{2} {v}_{2}}{\partial {x}_{1} \partial t} + \frac{{\partial }^{2} {v}_{1}}{\partial {x}_{2} \partial t} ) - {p}_{, 2} - ρ \frac{{\partial }^{2} {v}_{2}}{\partial {t}^{2}} = 0\end{matrix} , where {v}_{1}$$
is particle horizontal vibration velocity, v₂ is the particle vertical vibration velocity, x₁ is a physical spatial scale of abscissa, x₂ is a physical spatial scale of ordinate, p_{,1} is a partial derivative of Lagrange operator p that satisfies the incompressibility constraint with respect to a horizontal direction, and p_{,2} is a partial derivative of the Lagrange operator p that satisfies the incompressibility constraint with respect to a vertical direction; and
simplifying the expression form of the particle vibration velocity in the two-dimensional space by introducing the stream function, to acquire the inhomogeneous viscoelastic wave equation as follows:
$${v}_{1} = \frac{\partial ψ}{\partial {x}_{2}} , {v}_{2} = - \frac{\partial ψ}{\partial {x}_{1}} ,$$
where ψ is the stream function.

18. The non-transitory computer readable storage medium according to claim 16, wherein the loss function comprises a data error loss function, and a partial differential equation loss function; wherein
the data error loss function is
$${L}_{Data} = m s e ( {v}_{2} - {v}_{2}^{*} ) ,$$
where L_{Data} is data error loss, mse is mean square error, v₂ is the particle vertical vibration velocity, and
$${v}_{2}^{*}$$
is a particle vertical vibration velocity serving as the supervisory data;
the partial differential equation loss function is as follows:
$${L}_{PDE 1} = mse ( {p}_{, 1} + ρ {v}_{1 , tt} - μ ( {v}_{1 , 11} + {v}_{1 , 22} ) - η ( {v}_{1 , 11 t} + {v}_{1 , 22 t} ) - 2 {μ}_{, 1} {v}_{1 , 1} - {μ}_{, 2} ( {v}_{1 , 2} + {v}_{2 , 1} ) - 2 {η}_{, 1} {v}_{1 , 1 t} - {η}_{, 2} ( {v}_{1 , 2 t} + {v}_{2 , 1 t} ) ) ; and$$
$${L}_{PDE 2} = mse ( {p}_{, 2} + ρ {v}_{2 , tt} - μ ( {v}_{2 , 11} + {v}_{2 , 22} ) - η ( {v}_{2 , 11 t} + {v}_{2 , 22 t} ) - 2 {μ}_{, 2} {v}_{2 , 2} - {μ}_{, 1} ( {v}_{1 , 2} + {v}_{2 , 1} ) - 2 {η}_{, 2} {v}_{2 , 2 t} - {η}_{, 1} ( {v}_{2 , 1 t} + {v}_{1 , 2 t} ) ) ;$$
where L_{PDE1} is first partial differential equation loss, p_{,1} is a partial derivative of Lagrange operator p that satisfies an incompressibility constraint with respect to a horizontal direction, ρ is a density, v_{1,tt} is a second-order derivative of horizontal vibrational velocity of the particle with respect to time, μ is the shear modulus, v_{1,11} is a second-order derivative of the particle horizontal vibration velocity with respect to a horizontal direction, v_{1,22} is a second-order derivative of the particle horizontal vibration velocity with respect to a vertical direction, η is the viscosity, v_{1,11t} is a partial derivative of v_{1,11} with respect to time t after calculating the second-order derivative of the horizontal vibrational velocity of the particle with respect to the horizontal direction; v_{1,22t} is a partial derivative of v_{1,22} with respect to time t after calculating the second-order derivative of the horizontal vibrational velocity of the particles with respect to the vertical direction, μ_{,1} is a partial derivative of the shear modulus with respect to the horizontal direction, v_{1,1} is a partial derivative of the particle horizontal vibration velocity with respect to the horizontal direction, μ_{,2} is a partial derivative of the shear modulus with respect to the vertical direction, v_{1,2} is a partial derivative of the particle horizontal vibration velocity with respect to the vertical direction, v_{2,1} is a partial derivative of the particle vertical vibration velocity with respect to the horizontal direction, η_{,1} is a partial derivative of the viscosity with respect to the horizontal direction, v_{1,1t} is a partial derivative of v_{1,1} with respect to time t after calculating the partial derivative of the particle horizontal vibration velocity with respect to the horizontal direction, η_{,2} is a partial derivative of the viscosity with respect to the vertical direction, v_{1,2t} is a partial derivative of v_{1,2} with respect to time t after calculating the partial derivative of the particle horizontal vibration velocity with respect to the vertical direction, v_{2,1t} is partial derivative of v_{2,1} with respect to time t after calculating the partial derivative of the particle vertical vibration velocity with respect to the horizontal direction, L_{PDE2} is second partial differential equation loss, v_{2,tt} is a second-order derivative of the particle vertical vibration velocity with respect to time t, v_{2,11} is second-order derivative of the particle vertical vibration velocity with respect to the horizontal direction, v_{2,22} is a second-order derivative of the particle vertical vibration velocity with respect to the vertical direction, v_{2,11t} is a partial derivative of v_{2,11} with respect to time t after calculating the second-order derivative of the particle vertical vibration velocity with respect to the horizontal direction, v_{2,22t} is a partial derivative of v_{2,22} with respect to time t after calculating the second-order derivative of the particle vertical vibration velocity with respect to the vertical direction, v_{2,2} is a partial derivative of the particle vertical vibration velocity with respect to the vertical direction, and v_{2,2t} is a partial derivative of v_{2,2} with respect to time t after calculating the partial derivative of the particle vertical vibration velocity with respect to the vertical direction; and
the loss function is L=λ_{PDE} (L_{PDE1}+L_{PDE2})+λ_{Data}L_{Data}, where L is the aggregate loss, λ_{PDE} is a hyperparameter of the partial differential equation loss function, and λ_{Data} is a hyperparameter of the data error loss function.

19. The non-transitory computer readable storage medium according to claim 16, wherein the inputting the multi-frame particle vertical vibration velocity of the object to be measured as supervisory data into the physics-informed neural network, to obtain a spatial distribution of the shear modulus and a spatial distribution of the viscosity of the object to be measured comprises:
setting time t and a spatial scale (x₁, x₂), wherein x₁ is a physical spatial scale of abscissa, and x₂ is a physical spatial scale of ordinate;
acquiring a current predicted stream function p and Lagrange operator p that satisfies an incompressibility constraint by the spatial-temporal neural network based on the time t and the spatial scale (x₁, x₂);
calculating particle horizontal vibration velocity v₁ and particle vertical vibration velocity v₂ by using the inhomogeneous viscoelastic wave equation based on the current predicted stream function ψ;
calculating data error loss by using a data error loss function in the loss function based on the calculated particle vertical vibration velocity v₂ and the multi-frame particle vertical vibration velocity of the object to be measured;
acquiring a current predicted shear modulus μ and a current predicted viscosity η by the spatial neural network based on the spatial scale (x₁, x₂);
calculating partial differential equation loss by using a partial differential equation loss function in the loss function based on the current predicted shear modulus μ, the current predicted viscosity η, the particle horizontal vibration velocity v₁ and the particle vertical vibration velocity v₂;
acquiring current aggregate loss by combining the partial differential equation loss and the data error loss;
adjusting network parameters of the physics-informed neural network in response to L/L₀≥ε and N′≤Nₑ being satisfied, and returning to the acquiring a current predicted stream function ψ and Lagrange operator p that satisfies an incompressibility constraint by the spatial-temporal neural network based on the time t and the spatial scale (x₁, x₂) for repeating, wherein L is the current aggregate loss, L₀ is initial loss, ε is a predetermined threshold, N′ is a number of iterations, and Nₑ is a maximum number of iterations; and
outputting the current predicted shear modulus μ and the current predicted viscosity η as the spatial distribution of the shear modulus and the spatial distribution of the viscosity of the object to be measured in response to L/L₀<ε or N′>Nₑ being satisfied.

20. The non-transitory computer readable storage medium according to claim 16, further comprising: before the inputting the multi-frame particle vertical vibration velocity of the object to be measured as supervisory data into the physics-informed neural network, to obtain a spatial distribution of the shear modulus and a spatial distribution of the viscosity of the object to be measured,
pre-training the physics-informed neural network.
